(19) United States
(12) Patent Application Publication
(10) Pub. No.: US 2009/0212052 A1
(43) Pub. Date: Aug. 27, 2009

(54) RECREATIONAL ICE CREAM MAKER

(76) Inventors: Patti Taboada, Brielle, NJ (US); Keith Taboada, Brielle, NJ (US)

Correspondence Address: Keith Taboada, 1005 Sunset Drive, Brielle, NJ, 08730, US

(21) Appl. No.: 12/036,526

(22) Filed: Feb. 25, 2008

(51) Int. Cl. B62J 11/00; A47J 43/00; A23L 3/36; B65D 21/02

(52) U.S. Cl. 220/23.87; 99/485; 224/414; 426/524

(57) ABSTRACT

An ice cream maker and method for using the same is provided. In one embodiment, an ice cream maker includes a barrel assembly which may be attached to a bicycle, stroller or other wheeled vehicle. In one mode of operation, the barrel assembly may be rotated as the wheeled vehicle is operated, by example and not by limitation, by contact with the wheel of a bicycle.

### BACKGROUND OF THE INVENTION

1. Field of the Invention

Embodiments of the invention generally relate to an ice cream maker suitable for use with bicycles, among other recreational apparatus.

2. Background

Biking and other recreational activities are fun. These activities are more enjoyable with ice cream.

Therefore, there is a need for an ice cream maker adapted for use with a bicycle and other recreational apparatus.

### SUMMARY OF THE INVENTION

Embodiments of the invention generally relate to an ice cream maker and method for using the same. Generally, embodiments of the invention allow making of ice cream while pursuing recreational activities, such as walking, skateboarding, pushing a stroller, pulling a wagon, bicycling and the like.

In one embodiment, an ice cream maker includes an outer housing, an inner housing and a base. The outer and inner housings have sealable interior volumes. The base has a mounting portion configured to secure the base to a wheeled vehicle. The base holding the outer housing in a manner that allows rotation of the outer housing relative to the base. The inner housing is dimensioned as to allow ice to be packed between the inner housing and the outer housing when the inner housing is disposed in the outer housing.

In another embodiment, a method for making ice cream is provided. In one embodiment, a method for making ice cream includes sealing ingredients for making ice cream in an inner housing, placing the inner housing in an outer housing, placing ice in the space between the inner and outer housings, securing the outer housing to a base such that the outer housing is free to rotate relative the base, and turning the outer housing using human energy expended during an recreational activity for a sufficient time to turn the ingredients into ice cream.

### BRIEF DESCRIPTION OF THE DRAWINGS

The teachings of the present invention can be readily understood by considering the following detailed description in conjunction with the accompanying drawings, in which:

FIG. 1 is a side view of a bicycle equipped with one embodiment of an ice cream maker of the present invention;

FIG. 2 depicts a top view of one embodiment of a vehicle mounting portion of the ice cream maker of FIG. 1;

FIG. 3 is a side view of a bicycle equipped with another embodiment of an ice cream maker;

FIG. 4 is a partial side view of vehicle mounting portion of the ice cream maker of FIG. 1;

FIG. 5 is a top view of the ice cream maker of FIG. 1;

FIGS. 6-7 are sectional views of one embodiment of a barrel assembly;

FIG. 8 is a side view of a bicycle equipped with another embodiment of an ice cream maker;

FIG. 9 is a partial sectional view of the ice cream maker of FIG. 8;

FIG. 10 is a side view of another embodiment of an ice cream maker;

FIGS. 11A-B are side and top views of one embodiment of an ice cream maker; and

FIGS. 12A-B are side and top views of one embodiment of an ice cream maker.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally provide an ice cream maker that is powered by a bicycle or other wheeled vehicle. The energy needed for turning the ice cream maker is obtained from the rotational motion of wheel of the vehicle. Alternatively, the ice cream maker may be driven directly by a mechanism engaged with the chain or gearing of the pedal or rear wheel. In this manner, a pleasant ride on the bicycle may be rewarded with delicious homemade ice cream generated during the ride. In other embodiments, the ice cream maker may be coupled to a recreational object such as a skateboard, stroller, wagon or stick, wherein the ice cream maker is rotated by contact with the ground (including streets, sidewalks, paths, parks, beaches, boardwalks, fields, etc.) as the object is propelled by human energy. The term ice cream utilized throughout this document is intended to include gelato, French ice cream, soft ice cream, frozen custard and other frozen deserts made by stirring a liquid while chilling until frozen.

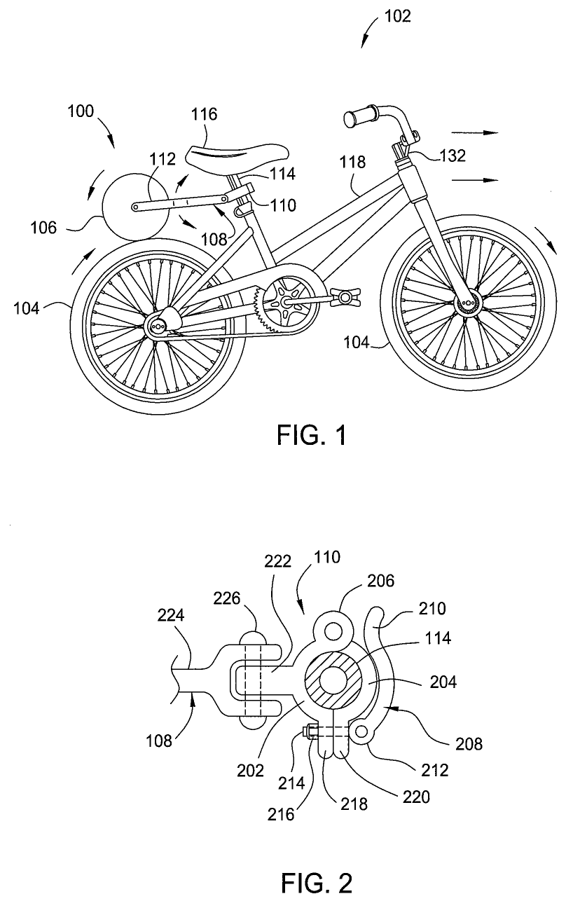

FIG. 1 is a side view of a bicycle 102 equipped with one embodiment of an ice cream maker 100 of the present invention. The ice cream maker 100 is powered by a wheel 104 of the bicycle 102. Although FIG. 1 depicts the ice cream maker 100 attached to a bicycle 102, it is contemplated that the ice cream maker of the present invention may be configured to be driven by wheels of other vehicles, configured to roll behind or ahead of a wheel of vehicle, be pushed or dragged while walking and the like.

The ice cream maker 100 generally includes a barrel assembly 106 and a base 108. The barrel assembly 106 is coupled to and rotatable on the base 108. The base 108 includes a vehicle mounting portion 110 and a barrel mounting portion 112. The vehicle mounting portion 110 is configured to securely couple the ice cream maker 100 to the bicycle 102. In one embodiment, the vehicle mounting portion 110 is configured to removably couple ice cream maker 100 to a seat post 114 that extends from a frame 118 of the bicycle 102 to support a seat 116 so that the barrel assembly 106 is driven by the rear wheel of the bicycle 102. It is also contemplated that the vehicle mounting portion 110 may be configured to removably couple ice cream maker 100 to a front portion of the frame 118 or steering fork assembly 132 so that the barrel assembly 106 is driven by the front wheel of the bicycle 102.

FIG. 2 depicts a top view of one embodiment of the vehicle mounting portion 110. The vehicle mounting portion 110 includes a clamp base 202 coupled to a clamp jaw 204 by a hinge 206. The clamp base 202 and the clamp jaw 204, when closed, are configured to clamp the seat post 114 therebetween. The clamp base 202 and the clamp jaw 204 may be secured by any suitable manner, for example, by fastener. In the embodiment depicted in FIG. 2, the clamp base 202 and the clamp jaw 204 are secured by an over-center clamp 208. The over-center clamp 208 includes a lever 210 coupled to a cam 212. The cam 212 is coupled to a rod 214 which is treaded into a retainer 216. The rod 214 extends though slots or holes (not shown) formed through lips 218, 220 projecting from the clamp base 202 and the clamp jaw 204. When the lever 210 is moved toward the clamp jaw 204, the cam 212 is rotated. The shape of the cam 212 displaces the rod 214 and retainer 216 towards the clamp jaw 212, thereby tightly sandwiching the lips 218, 220 between the cam 212 and the retainer 216 and clamping the seat post 114 between the clamp base 202 and the clamp jaw 204.

Referring now to FIGS. 1 and 2, a flange 222 of the mounting portion 110 extends from the clamp base 202 and is pivotably coupled with a fork 224 of the base 108. In the embodiment depicted in FIG. 2, the flange 222 and fork 224 are coupled by a pin 226, such as a clevis pin or other suitable pivot shaft, which allows the portion of the barrel mounting portion 112 of the base 108 to pivot in a vertical plane relative to the seat post 114 and wheel 104. Thus, gravity allows the weight of the barrel assembly 106 cause the barrel assembly 106 to come in contact with the wheel 104 so that the barrel assembly 106 rotates while the bicycle is ridden.

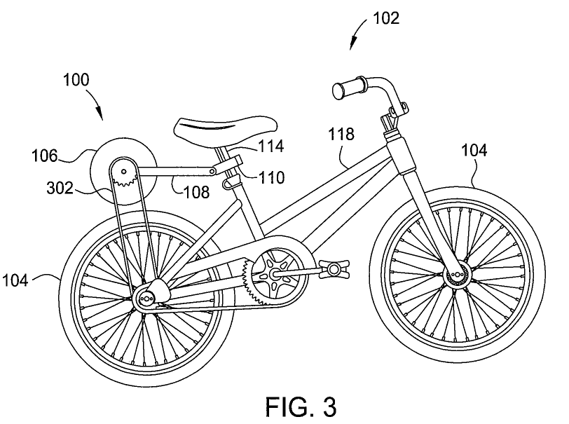

Alternatively, the barrel assembly 106 may be driven by a chain or gear assembly 302 which transfers the rotational motion of the wheel 104 or pedal 120 to the barrel assembly 106 as shown in FIG. 3.

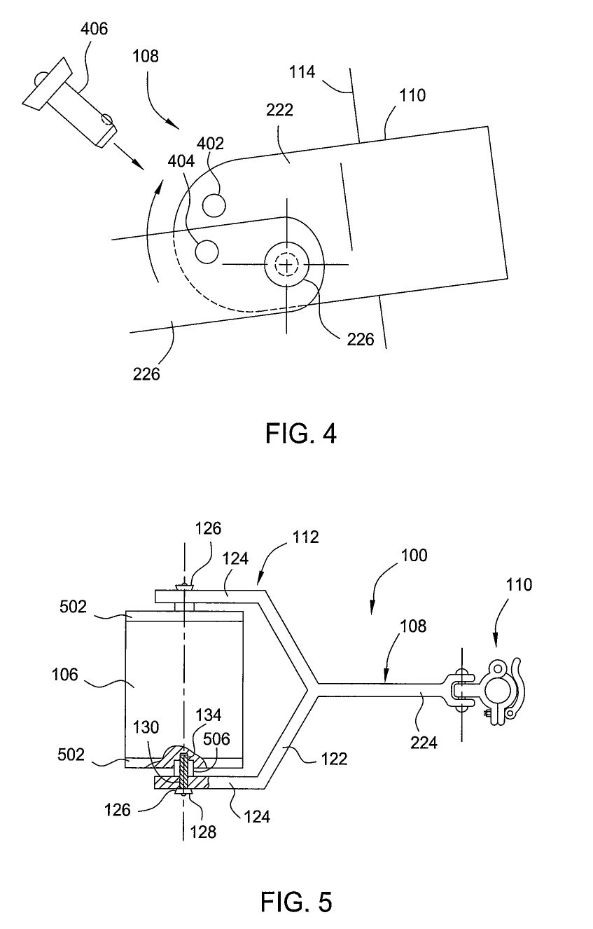

FIG. 4 illustrates another embodiment of the flange 222 and fork 224 of the base 108. The flange 222 may include a second hole 402 which aligns with a hole 404 formed in the fork 224 when the barrel assembly 106 is at a predefined position rotated clear of the wheel 104. A securing member 406, such as a threaded shaft and knob, clamp, clevis, fast pin and the link, may be inserted through the aligned holes 402, 404 so that the barrel assembly 106 is secured in a spaced apart relation relative to the wheel 104 so that the bicycle may be ridden without turning the barrel assembly 106 when desired.

Returning to FIG. 1, the barrel mounting portion 112 of the base 108 is coupled to the barrel assembly 106 in a manner that allows the barrel assembly 106 to, in one embodiment, rotate when in contact with the wheel 104. The barrel mounting portion 112 is also configured to allow the barrel assembly 106 to be readily detached from the base 108 so that the barrel assembly 106 (portion) of the ice cream maker 100 may be easily removed from bicycle 102.

Referring additionally to the top view of the ice cream maker 100 depicted in FIG. 5, the barrel mounting portion 112 includes a fork 122 having two fingers 124. Each finger 124 of the fork 122 includes an axis element 126 for allowing the barrel assembly 106 to rotate between the fork 126. The axis element 126 may be a shaft, rod, pin or other suitable element which allows the barrel to rotate. In one embodiment, the axis element 126 is a spring pin 128 that extends into the area between the fingers 124 when engaged with a hole 130 formed in the fingers 124. The ends of the spring pin 128 are configured to engage a blind hole 134 formed in the barrel assembly 106 and provide an axis upon which the barrel assembly 106 rotates. The ends of the spring pin 128 may be selectively retracted from the blind hole 134 to allow removal of the barrel assembly 106 from the fork 122. It is contemplated that the barrel assembly 106 may be coupled to the barrel mounting portion 112 in a number of different suitable manners which allow rotation and selective removal of the barrel assembly 106 from the barrel mounting portion 112.

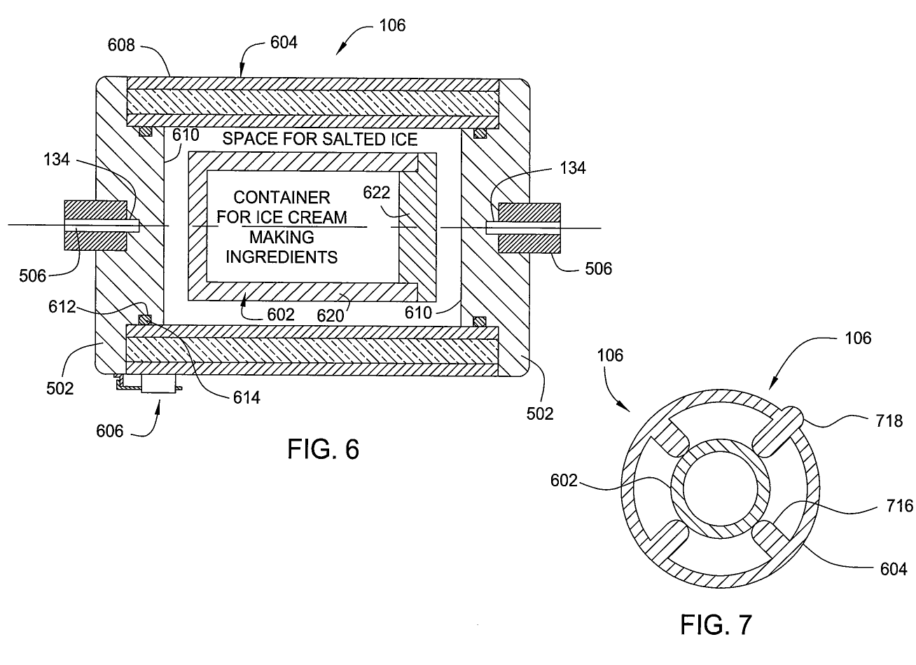

Referring additionally to sectional view of the barrel assembly 106 depict in FIG. 6, the barrel assembly 106 has two disk-shaped end caps 502. Each end cap 502 has one of the blind holes 134 formed therein. The blind hole 134 is configured to accept the portion of the axis element 126 when the axis element 126 is in its normal state extending through the finger 124. The blind hole 134 is sized to allow the barrel assembly 106 to rotate about the axis of the spring pin 128. Optionally, a bushing 506 fabricated from a bearing material, such as DELRIN® may be disposed in the blind hole 134 to further facilitate rotation of the barrel assembly 106 about the spring pin 128.

Referring now primarily to FIG. 6, the barrel assembly 106 includes an inner housing 602 and an outer housing 604. In the embodiment depicted in FIG. 6, both the inner and outer housings 602, 604 are cylindrical in form, although other shapes may be utilized. The inner housing 602 is dimensioned to fit within an interior volume of the outer housing 604. The dimensions of the inner housing 602 and outer housing 604 are selected such that the interstitial space between the housings 602, 604 may be packed with an amount of ice sufficient make ice cream in the inner housing 602. In one embodiment, the difference between an outer diameter of the inner housings 602 and an inner diameter of the outer housing 604 is at least about 2 inches to allow of packing of ice in the interstitial space.

In one embodiment, the outer housing 604 includes a shell 608 disposed between the end caps 502. The outer housing 604 is configured such that at least one of the end caps 502 may be detached from or moved relative to the shell 608 to expose an interior volume of the outer housing 604. In one embodiment, a first one of the end caps 502 is fastened, bonded or otherwise secured to the shell 608 is a substantially leak-free manner. The second one of the end caps 502 is secured to the shell 608 by at least one latch 606, three of which are contemplated in the embodiment of FIG. 6. The end cap 502 which is removable includes a boss 610 which extends into the shell 608. The boss 608 includes a seal gland 612 for housing a seal 614, such as a gasket or o-ring, which provides a seal between the end cap 502 and the shell 608.

In one embodiment, the end caps 502 and shell 608 may be fabricated from a polymer, wood or metallic material. At least one of end caps 502 and/or shell 608 may also be insulated. For example, the shell 608 may be fabricated from a doubled-wall cylinder having an insulating material disposed between the walls of the cylinder.

Referring to the sectional view of FIG. 7, the shell 608 may optionally include one or more inwardly extending ribs 716. The inwardly extending ribs 716 serve to maintain the housings 602, 604 in a substantially concentric orientation when the inner housing 602 is disposed inside the outer housing 604 while leaving space for ice.

The shell 608 may also include one or more ribs or other external surface feature 718 generally extending parallel to the axis of rotation. The external surface feature 718 is configured to cause the axis of rotation of the barrel assembly 106 to move relative to a rotational axis of the wheel 104 as the barrel assembly rotates in contact with the wheel. The external surface feature 618 may also cause the barrel assembly 106 to “jump” on the wheel 104 or other surface upon which the barrel assembly 106 rotates. It is believed that the movement of the axis of rotation of the barrel assembly 106 relative to the wheel 104 may assist in mixing the contents of the inner housing 602.

Referring back to FIG. 6, the inner housing 602 is generally a hollow member which may be opened to load the ingredients for making ice cream and for assessing the ice cream one made. In one embodiment, the inner housing is a canister 620 having a cap 622. The cap 622 is utilized to seal the canister 620. In one embodiment, the canister 620 is fabricated from a thermally conductive material such as aluminum or other suitable metal. It is also contemplated that the canister 620 may be fabricated from a polymer. The canister 620 is fabricated or coated with a material suitable for holding the ice cream without contamination.

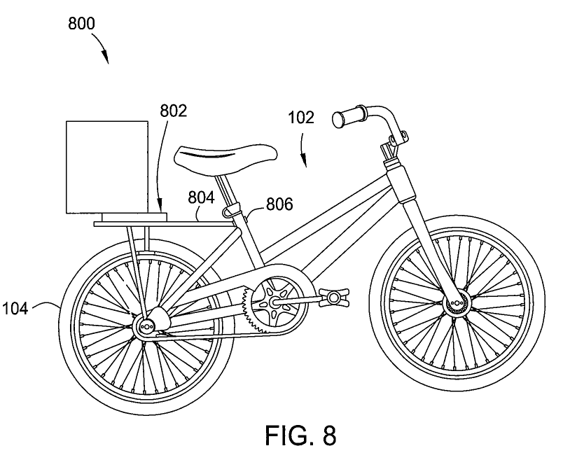

FIG. 8 is a side view of a bicycle 102 equipped with another embodiment of an ice cream maker 800. The ice cream maker 800 is similar to the ice cream makers described above, except that the rotation of the ice cream maker 800 is driven by the gear assembly 802 which turns the barrel assembly 106 of the ice cream maker 500 in a substantially vertical orientation. The gear assembly 802 may be driven by contact with the wheel 104, or by the pedal or chain of the bicycle.

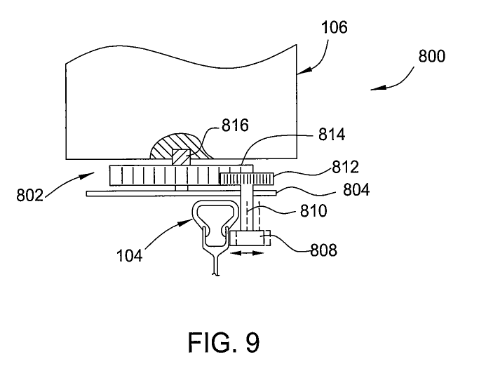

FIG. 9 is partial sectional view of one embodiment of the ice cream maker 800 of FIG. 8. The ice cream maker 800 includes a base 804 that is coupled to the bike 102. The base 804 has a bracket 806 that removably secures the barrel assembly 106 to the base 804. When installed in the base 804, the barrel assembly 106 is engaged with the gear assembly 802. The gear assembly 802 includes a drive wheel 808 that may be selectively brought in contact with the wheel 104 of the bicycle 102. The drive wheel 808 is coupled by a shaft 810 to a first gear 812. The first gear 812 is engaged with a second gear 814. The second gear 814 has a shaft 816 extending therefrom which includes a feature (such as a flat, hex, key or the like) which engages with a mating feature of the barrel assembly 106 such that rotational motion of the drive wheel 808 is transmitted to the barrel assembly 106 when the bicycle 102 is ridden.

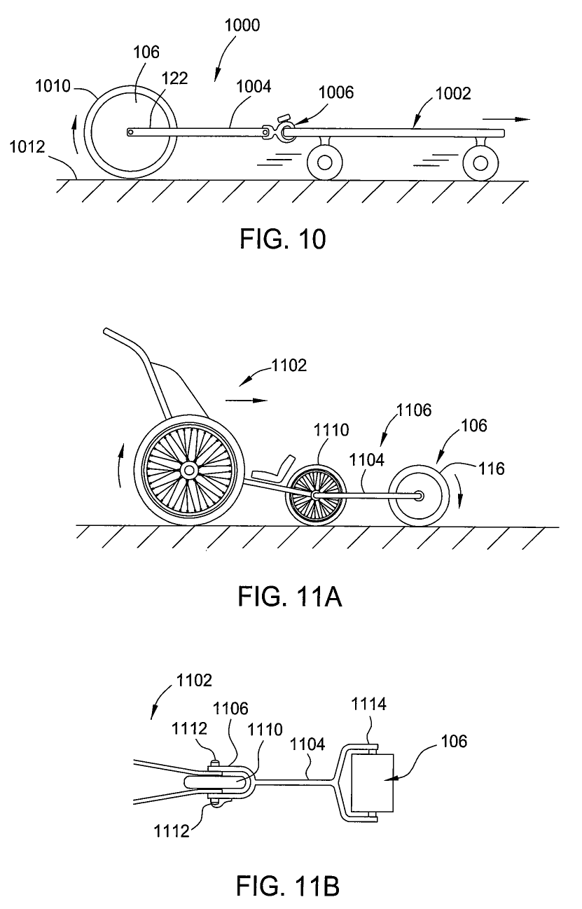

FIG. 10 is an isometric view of one embodiment of an ice cream maker 1000. The ice cream maker 1000 includes a base 1004 that is coupled to a rolling object 1002, such as skateboard, stroller, scooter or wagon, among others. The base 1004 has a clamp 1006 that removably secures base to the edge of the object 1002. The end of the base 1004 opposite the clamp 1006 includes a fork 122 for removably securing a barrel assembly 106 to the base 1004. The barrel assembly 106 may optionally include one or more sleeves 1010 which protect the barrel assembly 106 from contact with the ground 1012. The sleeve 1010 may be a polymer ring, and is one embodiment is a tire. When installed in the base 1004, the barrel assembly 106 rolls along the ground as it is towed by the object 1002 as the object 1002 is propelled forward by the rider, pusher or puller of the object.

FIGS. 11A-B are side and top views of one embodiment of an ice cream maker 1100. The ice cream maker 1100 includes a base 1104 that is coupled to a rolling object 1102, such as bicycle, scooter or stroller, among others. In one embodiment, the base 1104 has a first fork 1106 and a second fork 1114. The first fork 1106 removably secures base 1104 to a front wheel 1110 of the object 1102. In one embodiment, coupling of the first fork 1106 to the front wheel 1110 of the object 1102 may be accomplished by securing the first fork 1106 inside the axle nuts 1112 of the front wheel 1110. It is contemplated that the first fork 1106 may alternatively be coupled to the rear wheel of the rolling object 1102.

The second fork 1114 is on the end of the base 1104 opposite the first fork 1106. The second fork 1114 is configured similar to the fork 122 described above for removably securing a barrel assembly 116 to the base 1104.

The barrel assembly 116 may optionally include one or more sleeves 1116 which protect the barrel assembly 116 from contact with the ground 1118. When installed in the base 1104, the barrel assembly 116 rolls along the ground as it is pushed (or pulled) by the object 1102 as the object 1102 is propelled forward by its rider, pusher or puller of the object.

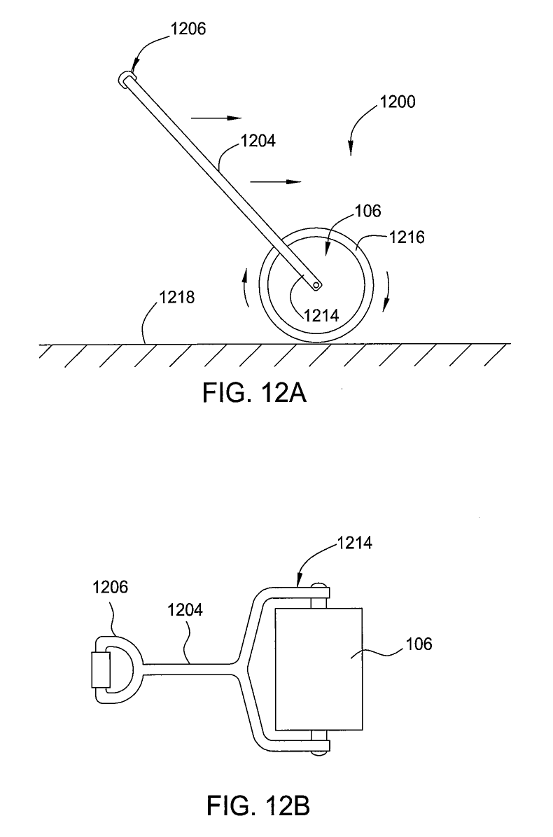

FIGS. 12A-B are side and top views of one embodiment of an ice cream maker 1200. The ice cream maker 1200 includes a base 1204 includes a handle 1206 at one end and a fork 1214 at the end of the base 1204 opposite the handle 1206. The handle 1206 is generally long enough to allow the operator of the ice cream maker 1200 to comfortably push the barrel assembly 106 along the ground 1218 as the operator walks. The fork 1214 is configured similar to the fork 122 described above for removably securing a barrel assembly 126 to the base 1204.

The barrel assembly 126 may optionally include one or more sleeves 1216 which protect the barrel assembly 126 from contact with the ground 1218. When installed in the base 1204, the barrel assembly 126 rolls along the ground as it is pushed (or pulled) by the object 1202 as the object 1202 is propelled forward by its rider, pusher or puller of the object.

Operation of one embodiment of the ice cream maker is now described primarily with reference to FIGS. 1-3. In operation, the inner housing 302 is loaded with ice cream making ingredients while the barrel assembly 106 is removed from the bicycle. Recipes for making home-made ice cream may be found in numerous publications, including those available the internet. The inner housing 302 containing the ice cream making ingredients is sealed. The inner housing 302 is then set on a bed of salted ice disposed in the bottom of the outer housing 304. The interstitial space between the outer and inner housings 302, 304 is packed with more salted ice. Once the outer housing 304 is filled with salted ice surrounding the inner housing 304, the outer housing 304 is sealed.

The sealed barrel assembly 106 is then mounted to the barrel mounting portion 112 of the base 108. The sealed barrel assembly 106 is allowed to contact the wheel 104 of the bicycle 102.

The bicycle 102 is then ridden so that the sealed barrel assembly 106 is rotated the wheel 104 of the bicycle 102. Embodiments of the barrel assembly 106 having external ribs will “jump” on the wheel 104 to assist mixing. It will take about 30 minutes or so for the ice cream making ingredients within the barrel assembly 106 to turn into ice cream. Riding the bicycle 102 quickly will inject more air into the ice cream formed within the barrel assembly 106, resulting in ice cream having a “soft-serve” consistence. A slower, more leisurely ride will result in a denser ice cream product.

Once the bicycle has been ridden for sufficient time to allow for the ice cream to form, the inner housing 302 may be removed from the outer housing 304 and opened to allow access to the ice cream. Optionally, the barrel assembly 106 may be lifted and secured spaced above the wheel 104 so mixing stops and the ice cream may be enjoyed later. Once ice cream making is completed, the barrel assembly 106 may be lifted and secured spaced above the wheel 104 so that the bicycle 102 may be ridden unencumbered by the barrel assembly 106 contacting the wheel 104.

The other embodiments operate similarly by pushing a stroller, pulling a wagon, skateboarding, operating a scooter, pushing the barrel assembly while walking and the like. Enjoy.

Although various embodiments which incorporate the teachings of the present invention have been shown and described in detail herein, those skilled in the art can readily devise many other varied embodiment that still incorporate these teachings.

What is claimed is:

1. An ice cream maker, comprising:
an outer housing having a sealable interior volume;
a base having a mounting portion configured to secure the base to the bicycle, the base holding the outer housing in a manner that allows rotation of the outer housing relative to the base; and
an inner housing having a sealable interior volume, the inner cylinder having dimensions selected to allow ice to be packed between the inner housing and the outer housing when the inner housing is disposed in the outer housing.

2. The ice cream maker of claim 1, wherein the outer housing has a sealable opening sized to allow the inner housing to pass therethrough.

3. The ice cream maker of claim 1, wherein the outer housing is insulated.

4. The ice cream maker of claim 1, wherein the outer housing is cylindrical.

5. The ice cream maker of claim 4, wherein the outer housing further comprises:
at least one feature coupled to and extending beyond an outer diameter of the outer housing such that the housing is out of round.

6. The ice cream maker of claim 1, wherein the mounting portion of the base further comprises:
a tube clamp.

7. The ice cream maker of claim 1 mounted to a bicycle, wherein the mounting portion is adjustable between a first position that holds the outer housing clear of a wheel of the bicycle and a second position that allows the outer housing to contact the wheel of the bicycle.

8. The ice cream maker of claim 1, wherein the outer housing further comprises:
features on opposing end that engages a feature of the base, at least one of the features of the outer housing and base allowing removal of the outer housing from the base, the features defining an axis of rotation of the outer housing.

9. The ice cream maker of claim 8, wherein at least one of the features of the outer housing is a hole.

10. The ice cream maker of claim 9, wherein at least one of the features of the base is a cylindrical member.

11. The ice cream maker of claim 9, wherein at least one of the features of the base is a spring pin.

12. An ice cream maker, comprising:
a barrel assembly comprising:
a first cylinder having a sealable opening; and
a second cylinder having a sealable interior volume, the second cylinder configured to fit through the opening of the first cylinder and fit within an interior volume of the first cylinder, and
a base for coupling the barrel assembly to wheeled object in a manner that allows the barrel assembly to be rotated as the object is operated.

13. The ice cream maker of claim 12, wherein the base further comprises:
a tube clamp at a first end; and
a fork at a second end opposite the first end.

14. The ice cream maker of claim 13, wherein the barrel assembly is removably coupled to the base between the fork in a manner that allows the barrel assembly to freely rotate relative to the fork.

15. The ice cream maker of claim 13, wherein the fork can rotate relative to the tube clamp in a plane perpendicular to a barrel rotation axis defined between the fingers of the fork.

16. The ice cream maker of claim 15, wherein the base further comprises:
an element that selectively fixes the rotation of the fork relative to the tube clamp.

17. The ice cream maker of claim 12, wherein the base and the barrel assembly comprise a consumer product packed in a retail product package.

18. The ice cream maker of claim 12, wherein the base further comprises:
a first fork at a first end configured to couple to the object; and
a second fork at a second end opposite the first end, the second fork configured to couple to the barrel assembly.

19. A method for making ice cream, comprising:
sealing ingredients for making ice cream in an inner housing;
placing the inner housing in an outer housing;
placing ice in the space between the inner and outer housings;
coupling the outer housing to an object; and
using the object, wherein motion of the object causes the outer housing to rotate.

20. The method of claim 19, wherein using the object to rotate the outer housing further comprises at least one of contacting the outer housing to a wheel of the object while riding a bicycle, towing the outer housing behind the object such that the outer housing rotates on the ground or pushing a stroller having the outer housing coupled thereto.
